(19) United States
(12) Patent Application Publication
(10) Pub. No.: US 2008/0172262 A1
(43) Pub. Date: Jul. 17, 2008

(54) Method and System for Disaster Mitigation Planning and Business Impact Assessment

(76) Inventors: Lianjun An, Yorktown Heights, NY (US); Stephen John Buckley, White Plains, NY (US); Ching-Hua Chen-Ritzo, Mahopac, NY (US); Pawan Raghunath Chowdhary, Montrose, NY (US); Thomas Robert Ervolina, Poughquag, NY (US); Daniel A. Ford, Mount Kisco, NY (US); Igor Frolow, Austin, TX (US); Naveen Lamba, Haymarket, VA (US); Young Min Lee, Old Westbury, NY (US); Prakaah Mukkarmala, Herndon, VA (US); Dharmashankar Subramanian, Tarrytown, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/622,705

(22) Filed: Jan. 12, 2007

(51) Int. Cl. G06Q 10/00

(52) U.S. Cl. 705/7

(57) ABSTRACT

The present invention provides a method and system making it possible to reduce a description of the impact of a disaster on the world at large to measurable, firm-specific operational and financial implications. This makes it possible to bridge the divide between disaster prediction and business planning by facilitating the translation of physical and other effects of a disaster on a business into a dollars-and-cents impact. The present invention also allows a user to evaluate the costs and benefits of various disaster mitigation plans and/or policies and to understand the combined effects of multiple mitigation plans.

### BACKGROUND OF THE INVENTION

1. Field of the Invention

The present invention generally relates to disaster prediction and mitigation planning and to disaster impact assessment.

2. Background Description

The frequency of natural and manmade disasters appears to be increasing globally. Examples of natural disasters include hurricanes, earthquakes, and pandemics. Examples of manmade disasters include drastic changes in economic conditions and geopolitical tensions leading to widespread labor unrest and war.

The impact of disasters on businesses grows as businesses become more globally integrated and interdependent, increasing businesses' reliance on partners and economies around the world. There has also been a trend towards reducing or eliminating redundancy in business systems and processes as companies have strived to reduce operating costs. This has in many cases left businesses more vulnerable to the risk of disaster-related disruption of their activities.

Traditionally, technologies used to predict the physical dynamics of disasters have been developed and utilized separately from technologies used to conduct and assess business operations. As a result, firms have not had access to fully adequate tools for integrating disaster planning into businesses processes.

### SUMMARY OF THE INVENTION

The present invention bridges the divide between disaster prediction and business planning by facilitating the translation of physical and other effects from a disaster into dollars-and-cents impact on a business. In this way, a description of the impact of a disaster on the world at large can be reduced to measurable operational and financial implications for a specific enterprise. The present invention also allows a user to evaluate the costs and benefits of various disaster mitigation plans and/or policies and to understand the combined effects of multiple mitigation plans. This is achieved through the systematic analysis of multiple disaster scenarios.

This invention can be used to assist business leaders in assessing the business impact of a potential disaster. The main objective of the model is to quantify the impact of a potential disaster to the business, including the effect of government and/or business mitigation actions. The model accomplishes this by analyzing the potential impact of a disaster on factors such as business operations, physical and information technology (IT) infrastructure, company employees, customers, suppliers, business partners, revenues, costs and customer service levels. Importantly, these analyses can be used to understand and demonstrate the impact that the disaster has on a company as it evolves over one or more time periods, and over one or more geographical locations. Therefore, this invention is able to capture dependencies/correlations that may exist over one or more time periods and across one or more geographical locations, where geographical dependencies may exist within a time period and/or across time periods. It also evaluates the impact of various mitigation plans on factors such as business operations, physical and information technology (IT) infrastructure, company employees, customers, suppliers, business partners, revenues, costs and customer service levels over one or more time periods and one or more geographical locations.

The present invention comprises one or more of the following: a disaster dynamics calculator, an infrastructure factors calculator, an economic factors calculator, a behavioral factors calculator and a business performance calculator.

The present invention thus provides a computer-implemented method, a system, and a machine-readable medium for instructing a computer to estimate the business impact and risk associated with a disaster by:
Computing tangible or intangible global dynamics of a disaster;
Computing psychological, economic and/or physical impacts of a disaster, including, but not limited to, potential interactions between such factors and disaster dynamics;
Computing financial and/or operational impacts of a disaster on at least one firm (including, but not limited to, potential interactions between firms) and
   The global dynamics of the disaster, as discussed above and
   The disaster's psychological, economic and physical impact, as discussed above;
Assessing the effects of various mitigation plans and/or policies (hereinafter, “mitigation plans”) and their implementation costs; and
Optimizing the mitigation plans relative to one or more business objectives.
   The system may be web-based, allowing users to access the computer implemented method via an internet connection.

Simulation may be used (i) to compute the global dynamics of a disaster and/or (ii) to measure the psychological, economic and physical impact of a disaster on a firm and/or the effects of various mitigation plans. A set of parameters and/or actions may be employed to characterize the mitigation plans. Examples of mitigation plan actions include keeping a safety stock of inventory, distribution of vaccines, cross training of employees, negotiating disaster clauses in supplier/customer contracts, and closing of a company site. Examples of mitigation plan parameters include the level of extra inventory to stock, the effectiveness of an evacuation or vaccination strategy, the starting and ending periods for the implementation of the plan, and the location(s) in which the plan is to be implemented.

The optimization of mitigation plans may involve (i) modifications to the structure of the dependencies between two or more of the firm's suppliers, business partners, customers, physical and IT infrastructure, and employees and/or (ii) modifications to the detailed parameters of the plans (iii) modifications to the durations of the plans, including the starting and ending period of the plans. The nature of these modifications may be determined through the design of one or more experiments which systematically explores the space of feasible parameters and actions, and identifies the combination of parameters and actions that optimizes the firm's performance with respect to one or more business objectives. Mitigation plans that are not controlled by the firm (i.e., government mitigation plans) may be imposed as constraints in the model.

The operational impact of a disaster on a firm may be measured in terms of available resources (e.g., people, materials, physical or IT infrastructure) allocated to demanded business processes, products and services. The detailed relationships and dependencies between available resources and demanded business processes, products and services may be captured by detailed enterprise dependency networks spanning multiple geographies and lines of business and/or global logistic networks.

The allocation of available resources to demanded business processes, products and services may be optimized using mathematical models, algorithms, and/or simulation. The demand for business processes, products, and/or services in each economic sector and line of business may be forecast using mathematical models that are sensitive to the effects of a disaster on various sectors of the economy and the availability of demand-generating and demand-sustaining resources (e.g., sales people) in each line of business.

A method or system for estimating the business impact of a disaster on a firm according to the present invention may therefore comprise:
a. Inputting the operational parameters for the firm which describe the products and services produced by the firm, the resources typically required to produce these products and services,
b. Inputting parameters to describe the severity of the disaster (note that this step may be replaced by estimating the severity of the disaster),
c. Estimating the impact of the disaster on the infrastructure upon which the firm depends,
d. Estimating the impact of the disaster on the economic factors upon which the firm depends,
e. Estimating the impact of the disaster on the behavior of the people upon which the firm depends, and
f. Estimating the business performance of the firm based on how the estimated infrastructure, economic factors, and behavior of people, will combine with the operational parameters of the firm.
   A further step may be added, as follows:
g. Disaster severity factors are expressed in terms of an epidemiological disaster.

In addition, or alternatively, a method or system for estimating the business impact of a disaster on a firm according to the present invention may comprise:
a. Inputting the operational parameters for the firm which describe the products and services produced by the firm, with the resources typically required to produce these products and services;
b. Inputting one or more disaster mitigation factors that the firm intends to deploy;
c. Inputting parameters to describe the severity of the disaster (note that this step may be replaced by estimating the severity of the disaster);
d. Estimating the impact of the disaster on infrastructure affecting the operation of the firm;
e. Estimating the impact of the disaster on the economic factors affecting the operation of the firm;
f. Estimating the impact of the disaster on the behavior of the people affecting the operation of the firm; and
g. Estimating the firm's business performance of the firm based on estimated infrastructure, economic factors, and behavior of people, in combination with the operational parameters of the firm.
   Further steps may be added, as follows:
h. Estimating the severity of the disaster using feedback between a disaster dynamics model and economic, behavioral and/or infrastructure factors (noting that the feedback may be prevented from looping infinitely by the presence of appropriate stopping criteria and loop tolerances);
i. Selecting a set of one or more mitigation actions resulting in an optimal estimated business performance as determined by one or more business objectives (noting that the selection may vary by time period and/or geographic location);
j. Using parameters that describe the disaster in terms of an epedemiological disaster;
k. Estimating financial performance of the firm based on business performance of the firm in the time horizon of the disaster;
l. If all sets of mitigation factors have been considered then continue to step (j), otherwise repeat from step (b) with another set of mitigation factors;
m. Select the set of mitigation actions which result in the best estimated business performance as determined by one or more business objectives.

It is recognized that machine-readable instructions may be stored on a machine-readable medium to instruct a computer or other data processing apparatus to perform steps according to the method of the present invention.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows the calculation of business impact according to the present invention.

FIG. 2 shows an example of a business performance calculator according to the present invention.

FIG. 3 shows an example of a potential sequence of steps for implementing the present invention.

FIG. 4 shows an example of a model framework for implementing the present invention.

FIG. 5 shows the architecture of a simulation manager according to the present invention.

### DETAILED DESCRIPTION OF A PREFERRED EMBODIMENT OF THE INVENTION

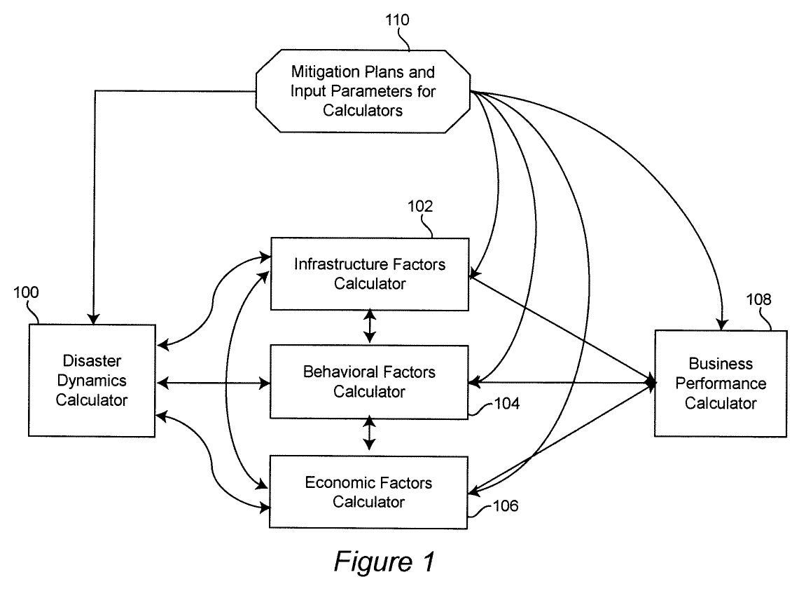

Referring now to the drawings, and more particularly to FIG. 1, mitigation plans and input parameters 110 are provided to a disaster dynamics calculator 100, an infrastructure factors calculator 102, a behavioral factors calculator 104, an economics factors calculator 106, and a business performance calculator 108.

The disaster dynamics calculator 100 computes one or more scenarios of how one or more disasters will evolve over time. This is achieved by utilizing models (e.g., systems dynamics, logic, regression) that capture the ‘physics’ of the disaster. For example, in the case of a pandemic, the disaster calculator computes the change in the number of susceptible, exposed, infected and recovered people in multiple geographical locations over a time horizon (e.g., 1 year). The computed values may be provided for multiple time periods within this horizon.

The output from the disaster dynamics calculator 100 may be used as input to an infrastructure factors calculator 102, an economics factors calculator 106 and a behavioral factors calculator 104. The infrastructure factors calculator 102 computes the predicted effect that the disaster dynamics may have on the availability of infrastructural elements such as buildings, electricity, water, internet connectivity and ground transportation networks at different geographical locations.

The economics factors calculator 106 computes the predicted effect that the disaster dynamics may have on key economic indicators (e.g., gross domestic product, demand for services/products by industry sector) for different geographical locations.

The behavioral factors calculator 104 computes the predicted social and psychological effects (e.g., fear of becoming infected during a pandemic, staying home from work to care for family members, social distancing, rioting, looting, political unrest, lowered morale) that the disaster dynamics may have on people in different geographical locations. The predictions computed by the infrastructure, economic and behavioral factors calculators 102, 104, 106 may be provided for a specific time horizon, and for various time steps within this horizon.

Additionally, there may be dependencies between the infrastructure, economic and behavioral factors. For example, if people decide to avoid going to work, then this may affect infrastructure that require humans to maintain/operate them. As another example, if the economy experiences a downturn and the unemployment index rises, people may decide not to purchase certain goods/services, which may further hurt the economy. Therefore, the output from one of these calculators may be used as input to another. Eventually, some equilibrium state may be achieved or feedback tolerances/stopping rules may be implemented in the invention to prevent the occurrence of infinite feedback loops. The precise sequencing of the calculations and the feedback of data between these calculators can be controlled by a simulation manager.

The results from the direct infrastructure, economic and behavioral factors calculators 102, 104, 106 may be fed back into the disaster dynamics calculator 100 to affect the evolution of the disaster. For example, in the case of pandemic, as the infected population grows, fear may cause people to stay home from work and distance themselves from others. Such behavioral factors may impact the dynamics of the pandemic in future periods by slowing the spread of the disease. Eventually, some equilibrium state may be achieved or feedback tolerances/stopping rules may be implemented in the invention to prevent the occurrence of infinite feedback loops. The precise sequencing of the calculations and the feedback of data between these calculators can be controlled by a simulation manager.

The final results from the infrastructure, economic and behavioral factors calculators 102, 104, 106 are fed to a business performance calculator 108, which computes the effect of the disaster on business performance measures. Examples of such measures include revenue, profit, cost and service level, over the given time horizon. Therefore, the business performance calculator 108 is able to determine the impact various infrastructure, economic and behavioral factors on specific business/enterprise operations.

Each of the disaster dynamics, infrastructure factors, economic factors, behavioral factors and business performance calculators 102, 104, 106, including any sub-calculators that they may comprise, may be calibrated by the user through a set of input parameters 110 that the user can control.

Mitigation plans 110 may be input to any one of the calculators 102, 104, 106. These mitigation plans 110 may be instigated by a either individuals and/or groups, including governments, businesses, and/or international organizations. Mitigation plans 110 may have the effect of modifying (typically improving) the disaster dynamics (e.g., distribution of vaccines may reduce the infection rate in the event of a pandemic). Mitigation plans 110 may also have the effect of modifying the impact of the disaster on behavioral factors (e.g., government announcements reassuring the public in the event of a terrorist threat may help to boost public morale). Mitigation plans 110 may also have the effect of modifying the impact of the disaster on economic factors (e.g., a government can implement farming subsidies or low interest loans in the event of a drought or flood to stabilize the agricultural economy). Finally, mitigation plans 110 may also have the effect of modifying the effects that a disaster has on business performance (e.g., purchasing of insurance will mitigate financial losses if infrastructure is destroyed, cross training workers may improve customer service if there is a general labor shortage, and securing of alternative suppliers of raw materials will mitigate supply shortages).

Mitigation plans 110 may be implemented by various parties (e.g., a business, a government, etc.). It is possible that the effects of mitigation plans that are put forth by different parties, or even by the same party, may not always be in alignment. For example, in the event of a pandemic, a business may offer financial incentives to encourage healthy workers to show up at work. This plan would mitigate the impact of the disaster on worker absenteeism in the short term but may increase the risk of these workers becoming infected in the long term. At the same time, a government or local authority may provide education to the public encouraging them to stay at home. This plan may mitigate the spread of the disease but would increase worker absenteeism in the short term. This invention can be used to determine trade-offs between competing mitigation plans 110, as well as to determine the combined effects of complementary mitigation plans (i.e., plans whose effects are in alignment).

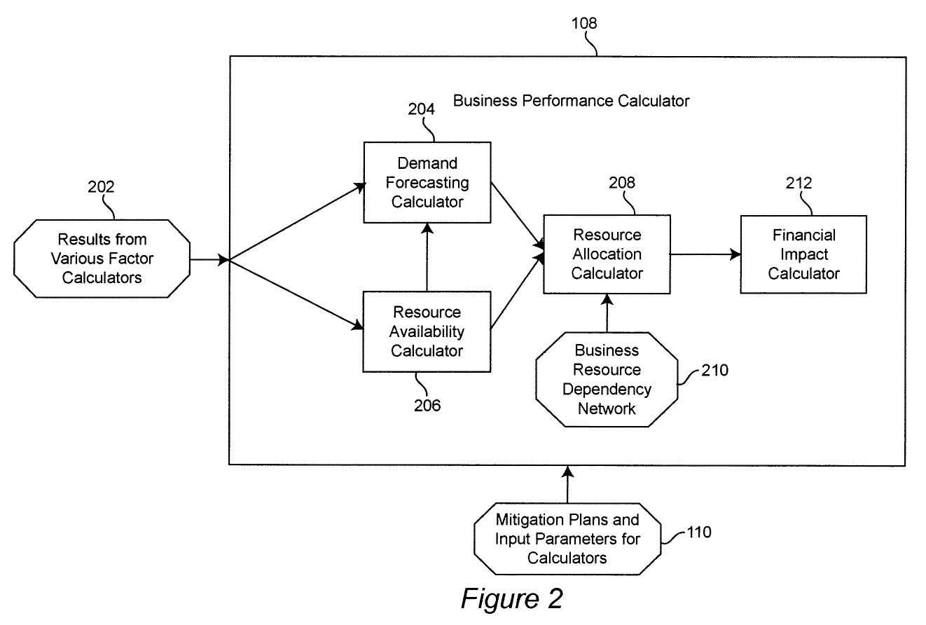

FIG. 2 provides a more detailed example of the business performance calculator. In this example, the business performance calculator 108 comprises a demand forecasting calculator 204, a resource availability calculator 206, a business resource dependency network 210, a resource allocation calculator 208, and a financial impact calculator 212. The business performance calculator 108 receives input from the infrastructure factors, behavioral factors and economic factors calculators 202, as well as information regarding input parameters and mitigation plans 110.

The resource availability calculator 206 may receive input 202 from the infrastructure, economic and behavioral factors calculators and produces a prediction of the availability of the human, material and infrastructural (e,g., information technology, electricity, facilities) resources that the business will have access to over the same planning horizon. These resources may be characterized by the geographical locations from which they are obtained, as well as by their physical or other properties (e.g., price and perishability in the case of material resource; wages and skills in the case of human resources). The resource availability predicted by the calculator may be a modification of a baseline resource availability that is provided as an input parameter to the resource availability calculator 206. This baseline represents the availability of resources under non-disaster conditions.

The demand forecasting calculator 204 may receive data 202 from the infrastructure, economic and behavioral factors calculators as well as the resource availability calculator 206 and produces a demand forecast for the products and services that the business offers to its customers/clients over a given planning horizon. This demand forecast may, for example, be expressed in terms of one or more of the following: demand volume (which may be stated in dollars, product units or full time equivalent employees) by day/week/month/quarter, customer type, customer location and industry sector. The demand forecast may depend on resource availability. For example, a reduced sales force may result in a lower demand forecast. The demand forecast produced may be a modification of a baseline demand forecast that is provided as an input parameter to the demand forecasting calculator 204, as shown in FIG. 1. This baseline demand forecast represents the demand forecast under non-disaster conditions.

The business resource dependency network 210 contains captures the relationships between each human, material and infrastructural resource and each product and/or service demanded. These relationships may be described at various levels of granularity, and relationships may depend on the location of resource, location of customers, customer account number, among other things. These relationships may also be tiered in the sense that a product/service may depend on the availability of one or more resources, which may in turn depend on the availability of one or more resources, and so on.

The resource allocation calculator 208 takes as input the business resource dependency network 210, the demand forecast and resource availability prediction. It determines an allocation of available resources to demanded products and/or services, taking into account resource requirement constraints, as defined by the dependency network. The allocation algorithm used by the resource allocation calculator 208 may be designed to prioritize certain products or services over other products or services. It may also prioritize the allocation of certain resources or other resources. In general, it may also optimize some performance measure such as maximizing revenue or minimizing cost.

The financial impact calculator 212 takes the results of the resource allocation calculator 208 as input and determines the expected cash flow, revenue, profit, cost and other financial indicators over the planning horizon. This calculator may take into account late payments, payment defaults, billing cycles, labor costs, contract payment structures, investment portfolios, costs of mitigation plans, exchange rates, interest rates and taxation, among other things.

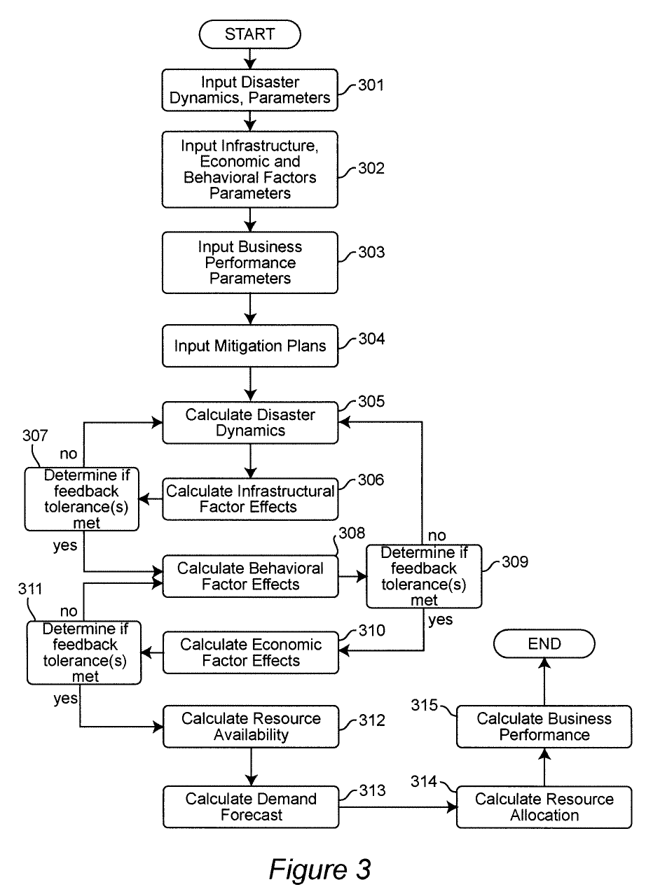

FIG. 3 provides an example of a potential sequence of steps for implementing the present invention. A user starts in step 301 by providing input parameters to the disaster dynamics calculator. These parameters may govern the dynamics of the disaster. For example, in the event of a hurricane, input parameters could include initial wind speeds and ocean temperature. As another example, in the event of a pandemic, input parameters could include disease transmissibility and human travel patterns. Next, in step 302, the user sets input parameters to each of the infrastructure, economic and behavioral factors calculators. Examples of infrastructure parameters are the sensitivity of electricity availability as a function of the intensity of a disaster (e.g., peak windspeeds in a hurricane) and river coverage (for determining the impact on clean water availability). Examples of economic parameters include a list of industry sectors and corresponding sensitivities to the disaster. Examples of behavioral parameters are the level of education of the population of interest and other demographic data such as age. Next, the user provides input parameters for the business performance calculator in step 303. These inputs could include, for example, the baseline demand forecast, baseline resource availability, terms and conditions for multiple contracts, exchange rates, cost of mitigation plans, operational costs, and prices for products and services. After parameterizing each of the calculators, the user may input one or more mitigation plans, step 304, each of which may affect the results of the calculations performed by any or all of the calculators.

After mitigation plans and all input parameters have been provided, the invention calculates the dynamics of the disaster in step 305. Subsequently, the invention calculates the impact of the disaster dynamics on infrastructural factors in step 306. If the infrastructure factors can influence the evolution of the disaster, as determined in step 307, then the invention re-computes the disaster dynamics, step 305, based on the updated infrastructure factor values. The iteration between the infrastructure calculator, as shown in step 306, and the disaster dynamics calculator, as shown in step 305, may continue until one or more user defined tolerance parameters are met. When the tolerance parameter(s) is (are) met, step 307, then the invention proceeds to calculate the behavioral effects of the disaster, as shown in step 308. Similarly, iteration between the behavioral effects calculator, as shown in step 308, and the disaster dynamics calculator, as shown in step 305, may continue until one or more user defined tolerance parameters, which may be different from the aforementioned tolerance parameters, are met. When the tolerance parameters are met as shown in step 309, the invention proceeds to calculate the economic effects of the disaster, step 310. In this example, economic effects may influence behavioral factors. Iteration between the economic calculator, as shown in step 310, and the behavioral effects calculator, as shown in step 308, may continue until a user defined tolerance parameter is met, as shown in step 311. In the process of iterating between steps 308 and 310, additional iterations between 305, 306 and 308, according to FIG. 3, may occur. That is, further iteration between the behavioral calculations in step 308 and disaster dynamics calculations in step 305 may occur, possibly resulting in further computation of infrastructure effects as shown in step 306 and iterations between the infrastructure calculator of step 306 and the disaster calculation of step 305. Notably, the sequence of performing disaster, behavioral, infrastructural and economic calculations, including the existence and directions of the feedback loops between the calculation steps can be modified from what is exemplified in FIG. 3, to suit the needs of the user.

After all necessary iterations, steps 307, 309 and 311, between the disaster, infrastructure, behavioral and economic calculators have been performed, the invention proceeds in step 312 to calculate the impact of relevant disaster modified infrastructure, behavioral and economic factors on resource availability. Next, the invention calculates the demand forecast, step 313, which may depend not only on disaster modified infrastructure, behavioral and economic factors, but on resource availability as well. Next, the invention calculates an appropriate allocation of available resources to the forecasted demand, as shown in step 314. This allocation can be performed, for example, by way of a mathematical optimization program, or other algorithm that optimizes one or more objectives of the firm. Finally, the invention computes the impact of the disaster on the business in step 315. Business impact may be measured financially, and/or otherwise (e.g., customer service levels), as may be implied by the ability of the company to complete its value generating operations (e.g., satisfying customer demand for products and services), for example.

To capture the evolution of the business impact time (i.e., over a given planning horizon), there are at least two ways of executing the sequence of steps in FIG. 3. The first way is to execute the sequence of steps in FIG. 3 exactly once, where in each step, input data is provided and results are computed for all periods in the planning horizon before completing the step. The second way is to execute the sequence of steps in FIG. 3 one or more times, where the number of times corresponds to the number of time periods considered in the planning horizon. In this case, data is provided and results are computed for only a single time period before completing each step in the sequence. If there is more than one time period in the planning horizon, then the sequence of steps in FIG. 3 is repeated until the final time period has been analyzed. In this second approach, the results computed in earlier time periods may influence the calculations for subsequent time periods.

The actual sequencing of calculations may be controlled by a simulation manager, which may also manage the data which is to be shared between calculators. This data may be stored in a database. The purpose of the simulation manager is to facilitate the display of the data on a web-based graphical user interface as well as execution of sub-models with appropriate data access and finally persistence of all the data into the data warehouse for final analysis.

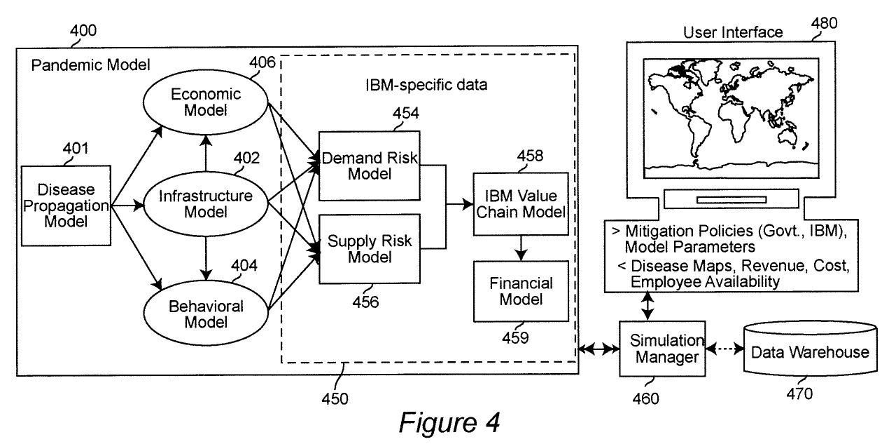

FIG. 4 shows a model framework for implementing the present invention in terms of a pandemic model 400 using firm-specific data 450 and employing a simulation manager 460 to enable both access to a data warehouse 470 and use of a personal computer 480 as a user interface.

A disease propagation model provides information on how many people in any geographic area are susceptible, exposed or recovered in each time-step (e.g., week or day). Output from the disease propagation model 401 is used as input to an infrastructure model 402, a behavioral model 404, and an economics model 406.

The infrastructure model 402 determines the impact of a pandemic on the business infrastructure, which includes electricity, air transportation, ground transportation, water, and the Internet. The infrastructure model 402 provides a predicted effect that disease propagation may have on the availability of infrastructural elements.

The behavioral model 404 determines the impact of a pandemic and of related mitigation actions on employee absenteeism. The behavioral model 404 thus provides predicted social and psychological effects that disease propagation may have on people.

The economic model 406 determines the impact of a pandemic on the economy, specifically on the gross output for key business sectors. The economic model 406 thus provides a predicted effect that disease propagation may have on key economic indicators.

The final results from the infrastructure, economic and behavioral factors calculators 402, 404, 406 are fed to a demand risk model 454 and a supply risk model 456. The demand risk model 454 determines the impact of a pandemic on the demand for a firm's products and services and may estimate changes in demand by country and by brand. The supply risk model 456 determines the impact of a pandemic on the supply of products and services needed to produce a firm's products and services.

A value chain model 458 estimates the impact of a pandemic on a firm's costs and revenues. The value chain model 458 thus receives input from the demand risk model 454 and the supply risk model 456 and determines an allocation of available resources.

A finance model 459 estimates the realized revenue and cash flow by incorporating the effect of customers delaying or defaulting on payments by different geographies and lines of business. The finance model 459 thus takes the results of the value chain model 458 as input to determine financial indicators over a planning horizon.

A simulation manager 460 provides the pandemic model 400 with data from a data warehouse 470 and controls the sequencing of calculations and the feedback of data. The simulation manager 460 may also receive user input (e.g., mitigation policies, model parameters) and provide user output (e.g., disease maps, revenue, cost, employee availability) via a personal computer 480.

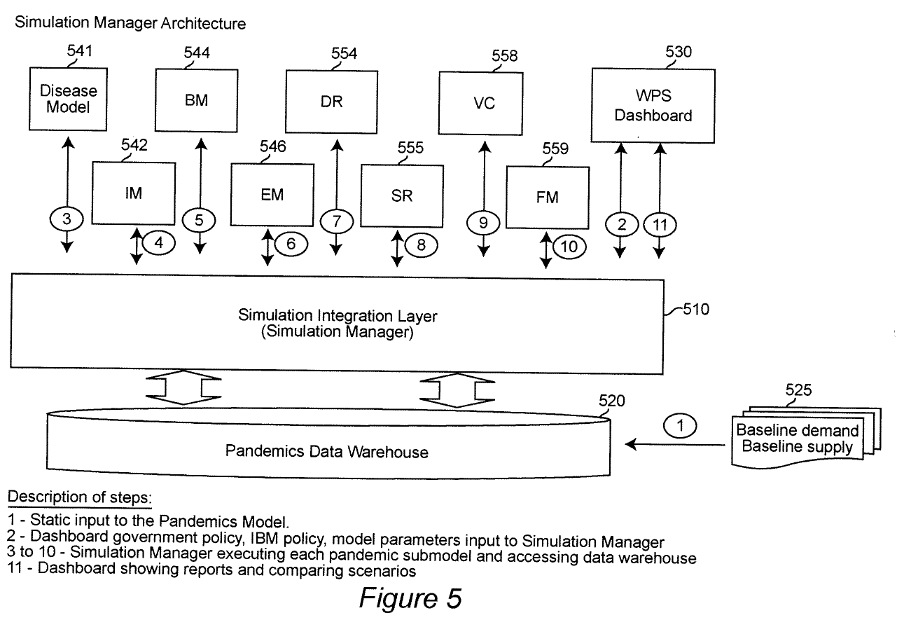

FIG. 5 shows the architecture of a simulation manager according to the present invention, consisting of three main parts: a simulation integrator 510, a data warehouse 520, and a dashboard model 530. Also shown are a disease model 541, an infrastructure model 542, a behavioral model 544, an economic model 546, a demand risk model 554, a supply risk model 555, a value chain model 558, and a finance model 559.

The simulation integrator 510 provides a framework that allows various pandemics sub-models components to plug-in to the solution. This may be accomplished, among other ways, by using the Java programming language to provide interfaces for the sub models to implement and plug-in at the run time. Such interfaces may provide enough information for the sub models to specify input data requirements, execution methodology and output data definition. When initiated, the simulation integrator 510 prepares the data (e.g., loading geography information, disease information, and so forth) and starts executing each sub model. Depending upon the workload, the simulation integrator 510 can spawn new processes to support the execution of additional pandemic models 541 in parallel. The diagram labels the steps that simulation integrator 510 performs in a sequential fashion and list of sub-models that get executed as follows:
Label 1: Load the baseline (normal) demand and supply data 525 for various line of business—a one time activity.
Label 2: The user creates a disease as well as a pandemic scenario and adds appropriate sub model parameters for a given run. The user can at this point in time run a disease model 541 or a pandemic model (shown in FIG. 4).
Label 3: If the user selects a disease model 541, the call goes to the simulation integration layer 510. The simulation integrator 510 reads the appropriate disease model parameters and invokes the disease model 541. The output of the disease model 541 is stored in the data warehouse 520.
Label 4: If user elects to run a pandemic model, the simulation integrator 510 gets the request and reads the sub model parameters specified by the user. The simulation integrator 510 then starts the run by executing the infrastructure model 542 first. The output of the infrastructure model 542 is saved in the database 520.
Label 5: Next the simulation integrator 510 executes the behavior model 544 taking the output from the infrastructure model 542 as input for the behavior model 544. The output from the behavior model 544 is stored in the data warehouse 520.
Label 6: Next the simulation integrator 510 executes the economic model 546 taking the output from the infrastructure model 542 as input for the economic model 546. The output of the economic model 546 is stored in the data warehouse 520.
Label 7: Next the simulation integrator 510 executes the demand risk model 554 taking output from the infrastructure model 542 and the economic model 546 as input as input for the demand risk model 554. The output of the demand risk model 554 is stored in the data warehouse 520.
Label 8: Next the simulation integrator 510 executes the supply risk model 555 taking output from the infrastructure model 542 and the economic model 546 as input as input for the supply risk model 555. The output of the supply risk model 555 is stored in the data warehouse 520.
Label 9: Next the simulation integrator 510 executes the value chain model 558 taking output from the demand risk model 554 and the supply risk model 555 as input as input for the value chain model 558. The output of the value chain model 558 is stored in the data warehouse 520.
Label 10: Next the simulation integrator 510 executes the finance model 559 to generate a cash balance. The output of the finance model 559 is stored in the data warehouse 520.

The WPS dashboard 530 follows the standard model view controller pattern for accessing, controlling and rendering a view. The dashboard framework communicates with the backend system to access the data using the Java Management Extension (JMX) layer. The simulation manager provides necessary framework to facilitate the exchange of the data between dashboard 530 and simulation integrator 510. The dashboard component, once they receive the data from backend, renders various web pages to display the data or collects the data from a graphical user interface as entered by end users and communicates back to the backend using JMX client APIs. The clear separation between data gathering at the backend and data rendering at the front end facilitates in the development of both such component in parallel there by saving time, cost and promote sharing of such component between dashboard 530 and simulation integrator 510.

The data warehouse 520, which contains both status data and model run time data, is a critical component in the simulation manager architecture. The static data is loaded only once at the start of the corresponding relational data tables as they created in the data warehouse. It consists of data that does not change during a modeling exercise (e.g., geography, airport information, company information, and so forth). The data warehouse 520 contains additional tables to efficiently store the large data generated during each pandemic simulation scenario execution. This data may then be used to perform the post model data analytics to understand the results of each scenario, their impact on end goal and for comparative analysis.

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A method for estimating a disaster's business impact on a firm, in one or more time periods and in one or more geographical locations, taking into account correlations between time periods and between locations, comprising the steps of:
inputting operational parameters of a firm, said operational parameters describing one or a plurality of products and services produced by said firm with resources required to produce said one or a plurality of products and services;
inputting parameters to describe a disaster in terms of severity;
estimating said disaster's impact on infrastructure affecting operation of said firm;
estimating said disaster's impact on economic factors required affecting operation of said firm;
estimating said disaster's impact on the behavior of people affecting operation of said firm; and
estimating said firm's business performance based on estimated infrastructure, economic factors, and behavior of people, in combination with the operational parameters of the firm.

2. The method of claim 1, further comprising the step of estimating said disaster's severity.

3. The method of claim 2, wherein said step of estimating said disaster's severity involves feedback between a disaster dynamics model and one or more of economic, behavioral, and infrastructure factors.

4. The method of claim 3, wherein said feedback does not loop infinitely due to the presence of one or more of appropriate stopping criteria and feedback loop tolerances.

5. The method of claim 1, wherein said steps of estimating said disaster's impact on infrastructure factors, economics factors and behavior of people involves feedback between any combination of said steps.

6. The method of claim 1, further comprising the step of selecting a set of one or a plurality of mitigation actions, resulting in an optimal estimated business performance as determined by one or more business objectives.

7. The method of claim 6, wherein said selection varies by one or a plurality of time period and geographical location.

8. The method of claim 1, wherein said step of estimating said firms' business performance includes an estimation of a disaster modified demand forecast, a disaster modified resource availability forecast, a resource allocation and financial impact.

9. The method of claim 1, wherein said parameters to describe a disaster in terms of severity are in terms of an epidemiological disaster.

10. A system for estimating a disaster's business impact on a firm, comprising:
a computer receiving as input operational parameters of a firm, said operational parameters describing one or a plurality of products and services produced by said firm with resources required to produce said one or a plurality of products and services;
a computer receiving as input parameters to describe a disaster in terms of severity;
a computer estimating said disaster's impact on infrastructure required to operate said firm;
a computer estimating said disaster's impact on economic factors required to operate said firm;
a computer estimating said disaster's impact on the behavior of people required to operate said firm; and
a computer estimating said firm's business performance based on estimated infrastructure, economic factors, and behavior of people, in combination with the operational parameters of the firm.

11. The system of claim 10, further comprising a computer estimating said disaster's severity.

12. The system of claim 11, wherein said computer estimates said disaster's severity using feedback between a disaster dynamics model and one or more of economic, behavioral, and infrastructure factors.

13. The system of claim 12, wherein said feedback does not loop infinitely due to the presence of one or more of appropriate stopping criteria and feedback loop tolerances.

14. The system of claim 10, wherein said estimation of said disaster's impact on infrastructure factors, economics factors, and behavior of people involves feedback between any combination of said disaster's impact on infrastructure factors, economics factors, and behavior of people.

15. The system of claim 10, further comprising selecting one or a plurality of mitigation actions resulting in an optimal estimated business performance as determined by one or more business objectives.

16. The system of claim 15, wherein said selection varies by one or a plurality of time period and geographical location.

17. The system of claim 10, wherein said estimation of said firms' business performance includes an estimation of a disaster modified demand forecast, a disaster modified resource availability forecast, a resource allocation and financial impact.

18. The system of claim 10, wherein said factors to describe a disaster in terms of severity are in terms of an epidemiological disaster.

19. A machine-readable medium for estimating a disaster's business impact on a firm, on which are included:
machine-readable instructions for instructing a computer to receive as input operational parameters of a firm, said operational parameters describing one or a plurality of products and services produced by said firm, with resources required to produce said one or a plurality of products and services;
machine-readable instructions for instructing a computer to receive as input parameters to describe a disaster in terms of severity;
machine-readable instructions for instructing a computer to estimate said disaster's impact on infrastructure required to operate said firm;
machine-readable instructions for instructing a computer to estimate said disaster's impact on economic factors required to operate said firm;
machine-readable instructions for instructing a computer to estimate said disaster's impact on the behavior of people required to operate said firm; and
machine-readable instructions for instructing a computer to estimate said firm's business performance based on estimated infrastructure, economic factors, and behavior of people, in combination with the operational parameters of the firm.
